(19) United States
(12) Patent Application Publication
(10) Pub. No.: US 2025/0205906 A1
(43) Pub. Date: Jun. 26, 2025

(54) METHOD FOR UNLOADING AT LEAST ONE CLAMPED PART, ASSOCIATED CLAMPING SYSTEM AND LOADING METHOD

(71) Applicant: STAUBLI FAVERGES, FAVERGES-SEYTHENEX (FR)

(72) Inventors: Sylvain Puget, Faverges-Seythenex (FR); Sylvain Chachereau, Cons-Sainte-Colombe (FR)

(21) Appl. No.: 18/849,469

(22) PCT Filed: Mar. 30, 2023
(86) PCT No.: PCT/EP2023/058329

§ 371 Date: Sep. 20, 2024

(30) Foreign Application Priority Data
Mar. 31, 2022 (FR) FR2202965

(51) Int. Cl. B25J 15/06

(52) U.S. Cl. CPC B25J 15/0608

(57) ABSTRACT

The unloading method is carried out with a magnetic clamping system which includes a detection device with a transmitter of an electromagnetic signal, controlled according to a force, and an electromagnetic signal receiver configured to output an output signal including a first value when the receiver receives the electromagnetic signal, and a second value otherwise. The method includes the steps including determining the force between a carriage and a hook and of comparing the force with a threshold value. If the force is higher than the threshold value, the transmitter is activated. Meanwhile, the output signal of the receiver is collected and the value included in the output signal is determined. If same is the first value, the entry of a demagnetization order of magnetic pads is authorized. Otherwise, the entry of the demagnetization order of the pads is prevented.

The present invention relates to a method for unloading, using a hoist, at least one clamped part on a magnetic clamping system of an industrial installation. The invention further relates to a magnetic clamping system configured for implementing such a method. Finally, the invention relates to a method for loading, using a hoist, at least one part to be clamped onto such a magnetic clamping system.

The present invention relates to magnetic clamping systems and to the methods of operation thereof, dedicated e.g. to plastics processing operations. In particular, the invention aims to improve rapid mold change procedures on injection molding machines and, more particularly, to limit the risk of the mold falling when unloading a mold with a lifting device such as a hoist.

In the field of rapid mold change on injection molding machine installations, it is known to use mechanical clamping systems to secure each mold part to a fixed part and a mobile part of the press. Since securing can be tedious, it was desired to make such operations less burdensome for operators, in the presence of heavy and dangerous loads, and in an industrial environment which is difficult in terms of space, heat and chemical vapors. The design of magnetic clamping systems made the profession develop toward the automation of procedures in order to reduce operating times and secure maneuvers with both parts of the mold between the plastic injection phases.

The operator uses a lifting device, usually of the hoist type, installed hereinabove the presses to convey the molds, according to the cycles needed for the production of various plastic parts.

During the handling phase, it is necessary to consider the states of two different environments, namely, the press installation and the lifting device, which do not usually communicate with each other. In particular, during mold unloading maneuvers in the injection molding machine, there is a risk of starting the demagnetization of the clamping plate mold, while the lifting device cannot, or cannot yet, hold the mold and hence fall thereof from the installation.

The activation and the deactivation of the electromagnets of a magnetic clamping system have so far been conditioned by the state of the injection molding machine but not by the state of the lifting device, the hoist not being designed to transmit status information to the magnetic clamping system or to communicate any loading data. Furthermore, the lifting device has a displacement mark, and the press has its own displacement mark, the distance between the lifting device and the press can be large, on the order of 5, 10 or 20 meters. However, the mold unloading operation between the press and the lifting means requires relatively precise positioning of the hoist hereinabove the mold to be unloaded, to prevent the swinging of the mold in the installation.

It may be noted that lifting devices such as hoists have their own calculator language and obey specific communication standards, so that plastics processing installations are hardly apt to communicate with the lifting devices in a network, nor apt to control the operation thereof. For the safety of installations and people, it is even preferable that the lifting device be controlled in position, speed or other way by the operator who is qualified for such operation, knowing the workshop environment, without the press installation returning to the hoist, information contradictory to the intended operation, which could be a source of failure or of incident.

It is known from EP1867437A to add to the magnetic pads of a magnetic clamping system, additional coils connected in series to a measuring circuit connected to a control unit, to measure the magnetic fluxes in the pad installation, and to monitor the mold movements to prevent same from falling. Overall, such solution is satisfactory. However, same does not address the problem of safely demagnetizing a mold, when taken over by the lifting device.

On the other hand, WO2008/142716A discloses a lifting device, with a test unit. Such lifting device has a load sensor for checking that the magnetic lifting force developed corresponds to the weight of the part being lifted. Such technology does not address the problem of demagnetization of a mold that needs to be unclamped for the extraction thereof from a press.

Thereby, with known equipment, the following incident situations cannot be excluded:
the hoist was positioned hereinabove the installation, but the hook was not coupled to the mold due to an operational error, with a risk of fall of the mold during demagnetization.
the mold can be coupled to the hoist, but the hoist is incorrectly positioned due to an operating error, with a risk of tipping-over of the mold or of an unlocking of the mold from the hoist during demagnetization.

Similar problems arise in other types of installations that comprise machines, parts of which have to be changed during the service life of the machines, such as machining centers.

It is such drawbacks that the invention seeks more particularly to remedy by proposing a new method of unloading, using a hoist, at least one part clamped on a magnetic clamping system, the method being more reliable than the methods of the prior art and making it possible to prevent dangerous situations to a large extent.

To this end, the invention relates to a method for unloading, using a hoist, at least one clamped part on a magnetic clamping system of an industrial plant, the hoist comprising:
a carriage movable in a horizontal plane,
a hook suspended from the carriage and movable vertically,
a hook load detection device, configured to determine a force between the carriage and the hook and
a control unit of the hoist.

The magnetic clamping system comprising:
a magnetic clamping control unit,
at least one magnetic clamping plate comprising a plurality of selectively magnetizable magnetic pads controlled by the magnetic clamping control unit,
a human-machine interface connected to the magnetic clamping control unit and allowing a demagnetization order to be entered for the magnetic pads

According to the invention,
the magnetic clamping system includes a device for detecting a position of the carriage relative to the clamping plate, the detection device comprising:
   an electromagnetic signal transmitter, secured to the carriage and controlled according to the force determined by the hook load detection device,
   a receiver for the electromagnetic signal emitted by the transmitter, fixed relative to the clamp plate and configured to provide an output signal including a first value when the receiver receives the electromagnetic signal and a second value when the receiver does not receive the electromagnetic signal, and
the unloading method comprising at least the steps consisting of
   a) determining the force between the carriage and the hook using the hook load detection device,
   b) comparing the force determined in step a) with a threshold value,
   c) if the comparison made in step b) shows that the force determined in step (a) is higher than the threshold value, operate the transmitter,
   d) during step c), collecting the output signal from the receiver,
   e) determining which value is included in the output signal of the receiver, among the first value and the second value,
   f) if the determination in step e) shows that the output signal collected in step d) includes the first value, authorizing the entry of an order to demagnetize the magnetic pads by means of the human-machine interface,
   g) if the determination in step e) shows that the output signal collected in step d) includes the second value, preventing the entry of the demagnetization order of the magnetic pads by means of the human-machine interface.

By means of the invention, the unloading method can only induce an effective demagnetization of the magnetic pads of the clamping system when the output signal of the receiver confirms that the hoist hook is actually under load and that the hoist carriage is correctly positioned relative to the clamping plate. The risks of untimely demagnetization of the magnetic pads of the clamping plate are thereby minimized.

According to advantageous but non-mandatory aspects of the invention, such a method can incorporate one or a plurality of the following features, taken according to any technically permissible combination:
Step g) is maintained as long as the signal collected in step d) has the second value.
The receiver delivers the output signal with the first value when the transmitter is activated and when the transmitter is in a predetermined position relative to the receiver and the receiver delivers the output signal with the second value when the transmitter is not operating and/or when the transmitter is not in the predetermined position with respect to the second element.
The predetermined position of the transmitter is opposite the receiver.
The predetermined position of the transmitter corresponds to a vertical alignment of the carriage with the clamped part on the magnetic clamping system.
The electromagnetic signal emitted by the transmitter includes an identification frame intended to be collected by the receiver, while the method comprises an additional step h) of comparing the identification frame collected by the receiver with a reference identification frame, and in the case where the result of the comparison in step h) is negative, the entry of the instruction to demagnetize the magnetic pads is prevented irrespective of the value determined in step e).
The unloading method comprises additional steps consisting of
   i) prior to step c), determining whether the receiver is operational,
   j) if the receiver is determined to be operational in step i), moving to step (e)
   k) if the receiver is determined to be non-operational in step i), switching to a manual mode where the operator has to validate at least one step by answering a question, using a control terminal connected to the magnetic clamp control unit.

According to another aspect, the invention relates to a magnetic clamping system comprising a magnetic clamping control unit and at least one magnetic clamping plate comprising a plurality of selectively magnetizable magnetic pads controlled by the magnetic clamping control unit, characterized in that:
the magnetic clamping system includes a device for detecting a position of a carriage of a lifting device relative to the magnetic clamping plate, the detection device comprising:
   an electromagnetic signal transmitter secured to the carriage,
   a receiver of the electromagnetic signal emitted by the transmitter, fixed relative to the clamping plate, configured to output an output signal including a first value when the receiver receives the electromagnetic signal and a second value when the receiver does not receive the electromagnetic signal,
the clamping system is configured to implement at least steps c) to g) of a method as described hereinabove.

The system of the invention serves to implement the method of the invention efficiently.

According to advantageous but non-mandatory aspects of the invention, such a system can incorporate one or a plurality of the following features, taken according to any technically permissible combination:
The electromagnetic signal is an infrared signal and the receiver is configured to detect an infrared signal.
The electromagnetic signal is emitted by a laser diode or a light emitting diode and the receiver is configured to detect a laser signal or a light emitting signal.
The receiver is directed along a vertical axis, while a reception zone of the receiver is in the form of a cone or truncated cone centered on the vertical axis.
The receiver is directed along a horizontal axis while a receiving zone of the receiver is in the form of a cone or truncated cone centered on the horizontal axis.
The receiver comprises a microcontroller apt to communicate the first value or the second value included in the output signal to the magnetic clamping control unit.
The receiver is configured to deliver a presence information to the magnetic clamping control unit.

According to a third aspect, the invention relates to a method for loading, using a hoist, at least one part to be clamped onto a magnetic clamping system of an industrial installation, the hoist comprising:
a carriage movable in a horizontal plane,
a hook suspended from the carriage and movable vertically,
a hook load detection device, configured to determine a force between the carriage and the hook and
a control unit of the hoist.

According to the invention,
the magnetic clamping system is as described hereinabove
the hook load detection device is configured to determine, based on the force between the carriage and the hook, the mass of the workpiece to be clamped.
the electromagnetic signal emitted by the transmitter includes information on the mass of the part to be clamped, determined by the hook load detection device,
The receiver is configured to extract the information on the mass from the part to be clamped from the electromagnetic signal received from the transmitter and to communicate same to the magnetic clamp control unit of the magnetic clamp system,
the loading method comprises at least steps performed by the magnetic clamping system and consisting of
   l) comparing the information on the mass of the part to be clamped, extracted from the electromagnetic signal, with a predetermined threshold value,
   m) if the comparison made in step (l) shows that the mass of the part to be clamped is greater than the threshold value, preventing the loading or emitting an alarm, and
n) if the comparison made in step (l) shows that the mass of the part to be clamped is less than the threshold value, authorizing the loading.

The invention will be better understood and other advantages of the invention will appear more clearly in the light of the following description of three embodiment of an unloading method, of a clamping system and of an unloading method according to the principle thereof, given only as an example and made with reference to the enclosed drawings, wherein:

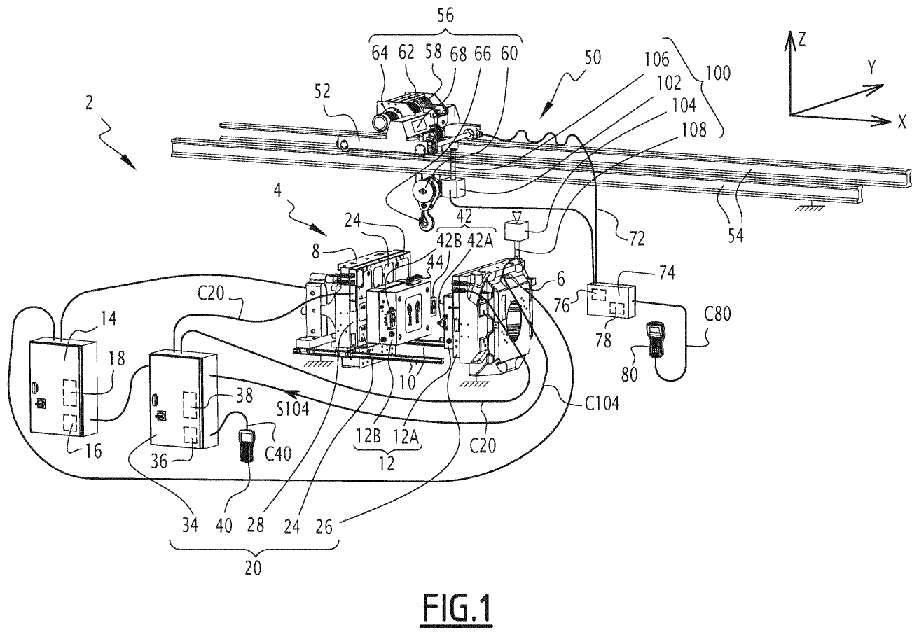

FIG. 1 is a schematic representation of the principle of an installation of injection molding machine incorporating a clamping system according to the invention and configured to implement a method according to the invention;

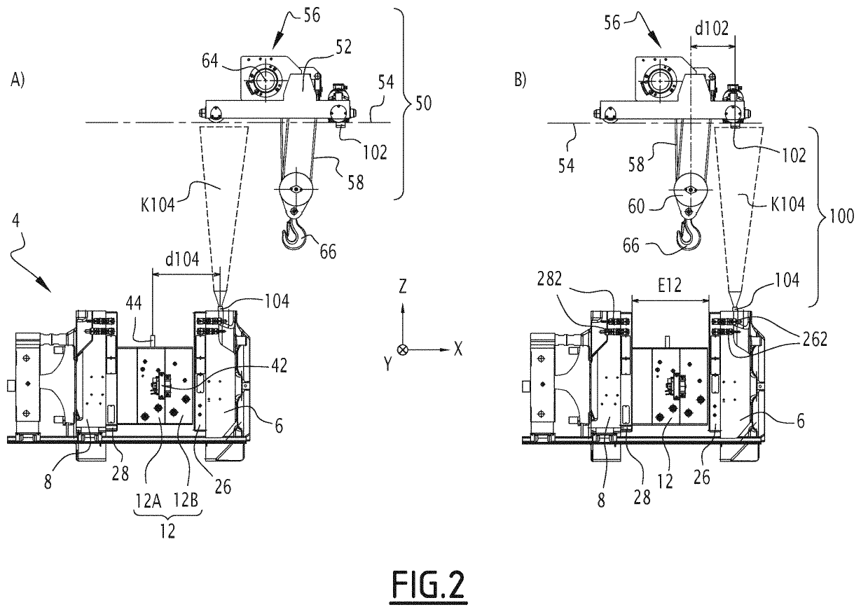

FIG. 2 shows, on two inserts A) and B), certain parts of the installation of FIG. 1 during two steps of an unloading method according to the invention;

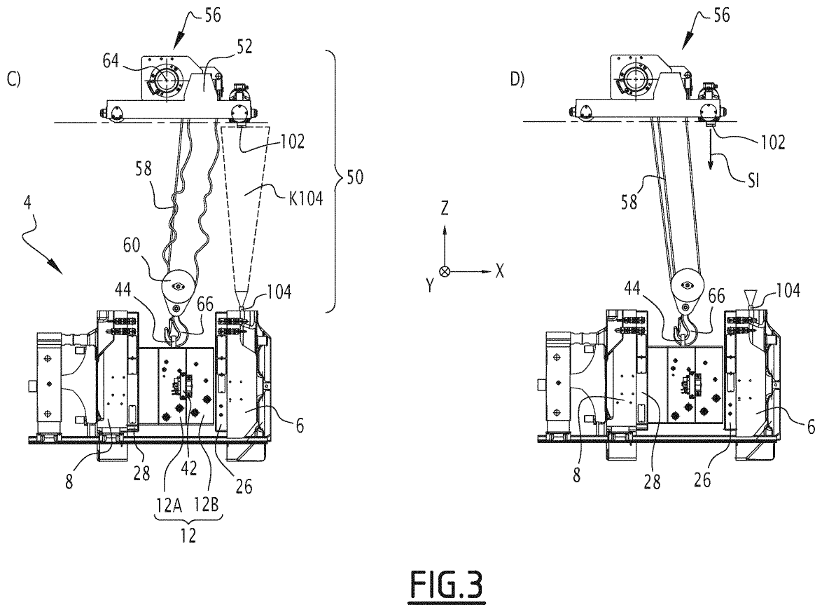

FIG. 3 shows, on two inserts C) and D), the same parts of the installation as FIG. 2, during two other possible steps of the unloading method;

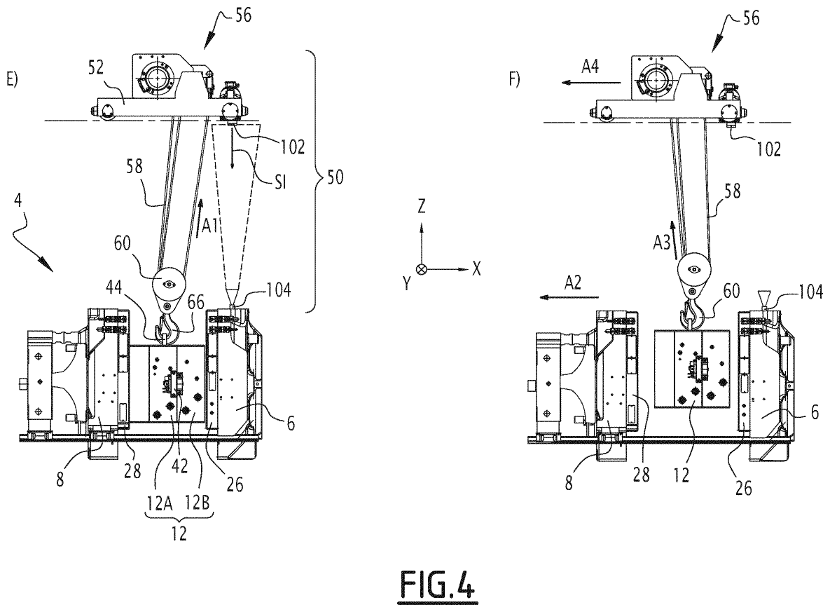

FIG. 4 shows, on two inserts E) and F), the same parts of the installation as FIGS. 2 and 3, during two other steps of the unloading method;

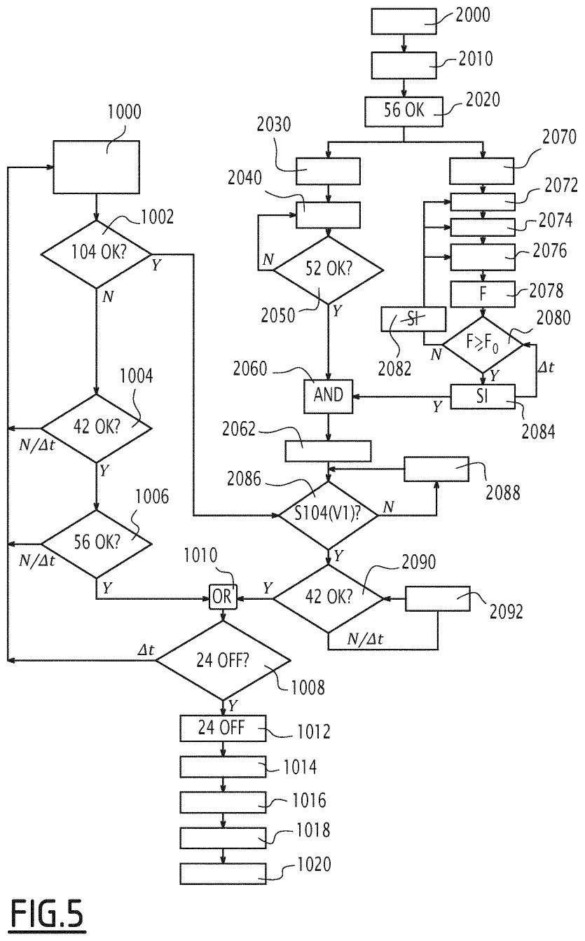

FIG. 5 is a block diagram of the unloading method according to the invention and implemented with the installation shown in FIGS. 1 to 4;

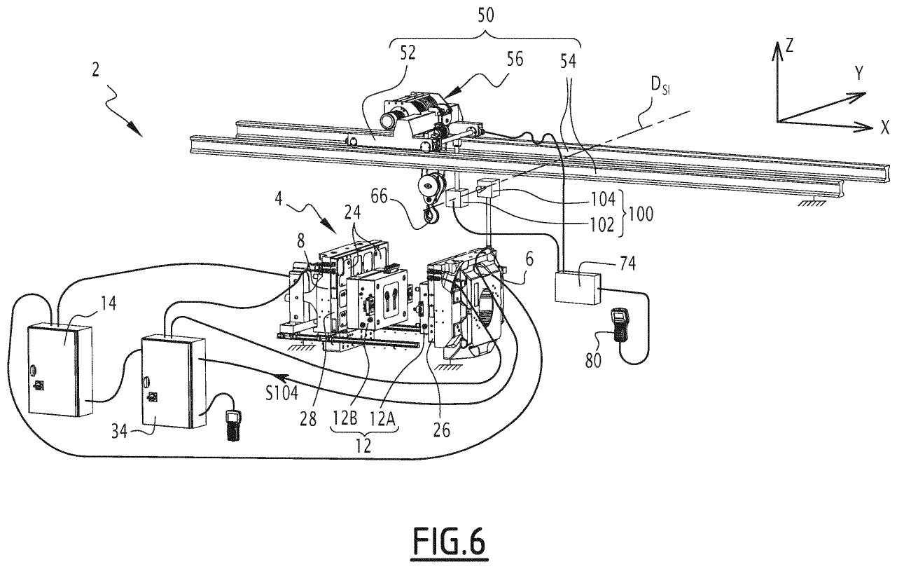

FIG. 6 is a view similar to FIG. 1, for an installation incorporating a clamping system according to a second embodiment and configured to implement a method according to the invention; and

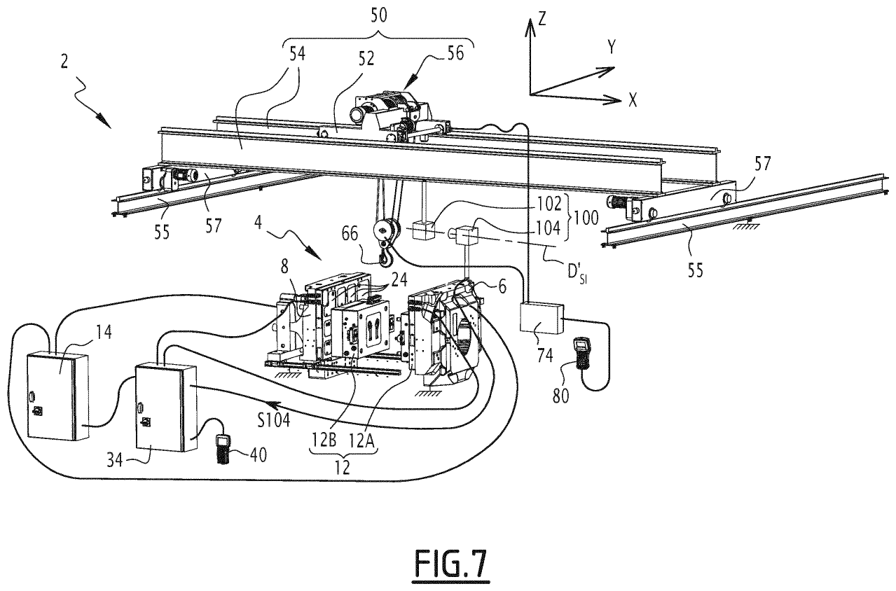

FIG. 7 is a view similar to FIG. 1, for an installation comprising a clamping system according to a third embodiment of the invention and configured to implement a method according to the invention.

The plastics processing installation 2 shown in FIG. 1 is part of a plant for converting synthetic material into molded parts. The installation comprises one or a plurality of manufacturing lines each formed by one or a plurality of injection molding machines, only one of which is shown in the figures with reference 4. The injection molding machine 4 comprises a fixed mount 6 and a movable platen 8 which can move parallel to an X axis of a fixed orthogonal reference system XYZ, being guided by rails 10 parallel to said axis. The X axis is horizontal, the Y axis is also horizontal and perpendicular to the X axis and the axis Z is vertical, thus perpendicular to the axes X and Y.

A mold 12, mounted on the injection molding machine 4, comprises two parts 12A and 12B which are made of a ferromagnetic material and which are secured to the fixed mount 6 and to the movable platen 8, respectively.

Thereby, the movements of the movable platen 8 parallel to the X axis serve to ensure the function of opening and of closing the mold 12 during the manufacture of molded parts.

The injection molding machine 4 further comprises a control unit 14 which includes in particular a calculator 16 enabling the injection molding machine 4 to be controlled according to a predetermined sequence stored in a memory 18.

The two parts 12A and 12B of the mold 12 are immobilized, on the fixed mount 6 and on the movable platen 8, respectively, by means of a magnetic clamping system 20 which comprises a plurality of magnetic pads 24, which are selectively magnetizable in the sense that same may or may not be selectively magnetized, i.e. same may be controlled to switch between a configuration wherein the pads are magnetized and a configuration wherein the pads are not magnetized, and vice versa. The magnetic pads 24 are distributed over a first clamping plate 26 immobilized by mechanical means on the fixed mount 6 and a second clamping plate 28 immobilized by other mechanical means on the movable platen 8.

The mechanical means for immobilizing the clamping plates 26 and 28 on the fixed mount 6 and on the movable platen 8 are advantageously screws.

In FIG. 1, only the magnetic pads 24 of the clamping plate 26 which are not covered by the part 12B of the mold are visible.

Advantageously, the magnetic pads are of the type of the pads described in EP1867437A. The invention is also suitable for a technology clamping plate where the magnetic pads are each identified by a North or South polarity and associated on a magnetic plate for clamping the mold. The invention is also suitable for a magnetic clamping plate of monolithic technology as described in EP2280803A.

The magnetic pads 24 are controlled by a magnetic clamping control unit 34 which also belongs to the magnetic clamping system 20 and which comprises a calculator 36 and a memory 38 associated with the calculator 36. The calculator 36 controls each of the magnetic pads 24 through control and power cables, which connect the magnetic clamping control unit 34 to the clamping plates 26 and 28, only one of which is visible in FIG. 1, with the reference C20.

By convention, it is considered that a part 12A or 12B of the mold 12 is mounted against the front face of a clamping plate 26 or 28. The front face of a clamping plate thus forms a clamping face of the plate on which the magnetic pads 24 supported the plate emerge. Each clamping plate 26 or 28 includes, at the rear face opposite the front clamping face thereof, housings (not shown) for receiving connection means 262 and 282 intended to electrically connect the various magnetic pads 24 to one another and to a terminal block (not shown) for connection to the magnetic clamping control unit 34 via the control cables C20 and equivalent [cables]. Grooves provided on the rear faces of each clamping plate 26 or 28 serve for the routing of electrical wires and the positioning of certain connection means 262 and 282.

The magnetic clamping system 20 further comprises a control terminal 40 to be handled by an operator and which interacts with the magnetic clamping control unit 34 through a wire connection represented by the cable C40 in FIG. 1 or, in a variant, through a non-wired link.

The function of the magnetic clamping control unit 34 is in particular to switch the poles of the magnetic pads 24 fastened on the clamping plates 26 and 28 according to the instructions of a program stored in the memory 38 and executed by the calculator 36 or the instructions received from the control terminal 40, which allows the operator to intervene to initiate, cancel or validate controls of the magnetic pads 24.

The control terminal 40 makes it possible in particular to hold the parts 12A and 12B fastened to the clamping plates 26 and 28, or to release the parts 12A and 12B from the clamping plates 26 and 28, by giving an operator the possibility of magnetizing or demagnetizing the magnetic pads 24 of the clamping plates 26 and 28, remotely by means of the control terminal. The control terminal 40 forms a human-machine interface. In a variant, the input of the demagnetization instruction can be carried out by means of a physical button connected to the control unit, which in such case forms a human-machine interface, or by means of another form of human-machine interface.

When the magnetic pads 24 are magnetized, because of an order received from the calculator 36 or from the terminal 40, the clamping control unit 34 controls a magnetic clamping force exerted by each clamping plate 26 or 28 on the corresponding mold part 12A or 12B.

Furthermore, the magnetic clamping control unit 34 is connected to different sensors (not shown), which are integrated into the magnetic clamping system 20 and which may comprise temperature sensors, mold presence sensors, etc.

The magnetic clamping system 20 is supplied with current through the injection molding machine 4.

On the other hand, the mold 12 comprises a locking mechanism 42 which is formed by a first part 42A mounted on the part 12A of the mold 12 and a second part 42B mounted on the part 12B of the same mold. The parts 42A and 42B are designed to cooperate, when the locking mechanism 42 is activated, in order to secure together the two parts 12A and 12B of the mold.

As can be seen in FIG. 1 with the two parts 42B arranged on either side of the part 12B of the mold 12, a locking mechanism 42 is advantageously provided on each of the two vertical sides of the two parts of the mold.

When not placed in the injection molding machine 4, the mold 12 is in a configuration where the locking mechanisms 42 thereof are activated, i.e. in a position where the two parts 12A and 12B of the mold are pressed and immobilized against each other by the mechanism(s).

The mold 12 is also equipped with a lifting eye bolt 44 which, in the example, is mounted on an upper face of the part 12B of the mold. Thereby, when the locking mechanism or mechanisms 42 are activated, the lifting eye bolt 44 serves to lift the entire mold 12.

The installation 2 further comprises a lifting device 50 which serves to move the mold 12 in space, along the three directions of the orthogonal reference system XYZ.

The lifting device 50 comprises a carriage 52 slidably mounted on two rails 54 parallel to the X axis. Thereby, the carriage 52 is movable in a horizontal plane parallel to the X and Y axes.

Preferably, when a plurality of injection molding machines 4 form part of the plastics processing installation 2, same are aligned parallel to the X axis, with the injection planes thereof parallel or perpendicular to said axis, so that the different injection molding machines are accessible to the same lifting device 50.

According to a variant of the invention, the rails 54 can be mounted so as to slide on beams (not shown) which extend parallel to the Y axis and which are fastened to the structure of a building which contains the plastics processing installation 2, as shown for the third embodiment only.

The lifting device 50 further comprises a hoist 56 mounted on the carriage 52 and which includes a cable 58 which supports a pulley block 60 and the winding of which on a drum 62 is controlled by an electric motor 64. A hook 66 is suspended from the pulley block 60 and also forms part of the hoist 56. The hook is movable vertically under the carriage 52, due to the winding of the cable 58 on the drum 62. The hook 66 is designed to interact with the lifting eye bolt 44 when it is necessary to lift the mold 12 with respect to the parts 6 and 8 of the injection molding machine 4.

The lifting device 50 further comprises a hook load detection device, which comprises a sensor 68 for the load of the hoist. Advantageously, the hook load detection device comprises the means (not shown) for processing the output signal of the sensor 68 for the load of the hoist. The load at the hoist corresponds to the tension of the cable 58. The sensor 68 can detect the tension and can send via a wire link 72, a signal corresponding to a control unit 74 which includes in particular a calculator 76 enabling the lifting device 50 to be controlled, and a memory 78. The wire link 72 also serves to supply electrical power to the motor 64.

In a variant, the output signal from the sensor 68 is supplied to the control unit 74 via a non-wired link.

The control unit 74 is provided to control the movement of the carriage 52 along the rails 54 and the rotation of the cable 58 on the drum 62 and to monitor a force F which is exerted between the carriage 52 and the hook 66 and which depends on the weight of the elements suspended from the carriage 52, more particularly on the weight of the pulley block 60, of the hook 66 and of the weight of the mold 12 when the mold 12 is suspended from the hoist 56 by the lifting eye bolt 44.

In practice, the force F monitored by the control unit 74 is the force detected by the sensor 68, which corresponds to a tensile force on the strands of the cable 68 which extend between the pulley block 60 and the drum 62. The tensile force opposes the magnetic force for holding the mold 12 on the clamping plate 26.

The control unit 74 may also comprise one or a plurality of power circuits (not shown), which serve to feed the electric motor 64 through the wire connection 72.

The lifting device 50 further comprises a control terminal 80 intended to be handled by an operator and which interacts with the control unit 74 through a wire connection represented by the cable C80 in FIG. 1 or, in a variant, through a non-wired link.

The magnetic clamping system 20 further comprises a device 100 for detecting a position of the carriage relative to the clamping plate 26. The position detection device 100 comprises an infrared transmitter 102 secured to the carriage 52 and an infrared receiver 104 secured to the frame 6 and thus fixed with respect to the clamping plate 26 which is immobilized on the frame.

In the example of the figures, the transmitter 102 is suspended from the carriage 52 by means of a rod 106. On the other hand, the receiver 104 is mounted [on] a mast 108 immobilized on the fixed mount 6.

Is a variant, and as shown in FIGS. 2 to 4, the transmitter 102 can be integrated into the carriage 52, while the receiver 104 is integrated into the fixed mount 6.

Herein, the transmitter 102 is fixed in the coordinate frame of the carriage 52, whereas the receiver 104 is fixed in the coordinate frame of the clamping plate 26, i.e. in the fixed orthogonal coordinate frame XYZ.

The receiver 104 is directed along a vertical axis, parallel to the Z axis, and configured to detect an infrared signal SI emitted by the transmitter 102 when the transmitter 102 is actuated and arranged above the receiver 104, inside a reception truncated cone K104 defined by receiver 104 and centered on the vertical axis. The receiver 104 comprises a detection zone configured to detect the infrared signal SI.

The reception truncated cone K104 gives a certain tolerance to the position of the detection device 100 because the receiver 104 can detect the infrared signal SI emitted by the transmitter 102 over an acceptable disc-shaped range, which extends in the XY plane of the coordinate frame XYZ, at the top of the truncated cone K104.

To provide efficient and smooth lifting of the mold 12 relative to the injection molding machine 4, the hook 66 should be correctly positioned with respect to the lifting eye bolt 44 before unclamping the mold 12 and lifting same by means of a tensile force directed upwards, by means of the hoist 56. However, the position of the lifting eye bolt 44 in the orthogonal reference frame XYZ varies according to the thickness E of the mold 12 which corresponds to the distance between the front faces of the clamping plates 26 and 28 measured parallel to the X axis. The transmitter 102 is secured to the carriage 52 and the receiver 104 is secured to the fixed mount 6 in positions such that the vertical alignment of the hook 66 on the lifting eye bolt 44 corresponds to a predetermined position of the transmitter 102 with respect to the receiver 104.

Advantageously, in such embodiment, the predetermined position is a position where the transmitter 102 is facing the receiver, in the present example vertically aligned with the receiver 104.

When the transmitter 102 is in the predetermined position, the carriage 52 is vertically aligned with the mold 12 clamped in the injection molding machine 4.

In the first embodiment shown in FIGS. 2 to 4, the direction of the infrared signal SI emitted by the transmitter 102 is parallel to the Z axis and directed downwards.

Advantageously, the direction of emission of the infrared signal SI is chosen so that the signal is concurrent with the receiver 104 only in a position of the carriage 52 which corresponds to the predetermined position of the transmitter with respect to the receiver 104.

d102 denotes a distance, measured parallel to the X axis, between the geometric center of the pulley block 60 and the point of emission of the infrared signal SI by the transmitter 102. d104 denotes a distance measured parallel to the X axis between the geometrical center of the reception zone of the receiver 104 and the geometrical center of the lifting eye bolt 44. The distances d102 and d104 are chosen according to the geometry of the injection molding machine 4 and of the carriage 52. The distances d102 and d104 correspond with each other so that the hook 66 is vertically aligned on the lifting eye bolt 44, in the predetermined position of the transmitter 102 with respect to the receiver 104.

The receiver 104 comprises a microcontroller (not shown), configured to communicate the state thereof to the magnetic clamping control unit 34 in the form of an electronic signal S104 transmitted via an electric cable C104 or, as a variant, via a non-wired link. The signal S104 comprises a status information of the receiver 104 which takes a first value V1 when the receiver 104 receives the infrared signal S1 transmitted by the transmitter 102 and a second value V2 when the receiver 104 does not receive the infrared signal.

For example, the first value V1 may be positive and the second value V2 may be negative.

If the transmitter 102 is in the predetermined position with respect to the receiver 104 without operating, i.e. without emitting the infrared signal SI, the receiver does not detect the signal and the output signal thereof includes the second value V2.

Advantageously, the receiver 104 is configured to send presence information to the magnetic clamping control unit 34, which enables same to be tested by the control unit, on a regular basis or on demand. For example, it may be provided so that the receiver 104 periodically sends the output signal S104 with the second value V2 to the clamping control unit 34, which serves to make sure that the receiver is in place, connected and operational, regardless of the position and of the activation of the transmitter 102. The reception of a first value V1 or of a second value V2 of the signal S104 by the receiver 104 is assimilated to the reception of presence information from the receiver 104. Furthermore, if the receiver 104 is detected as being in place, connected and operational, the analysis of the state of the receiver, on the basis of the two possible values of the output signal 104 can be used to authorize or to prohibit the demagnetization of the magnetic pads 24, in a secure manner, as explained hereinafter.

A method of unloading the mold 12 using the hoist 56 is now described with reference to FIGS. 2 to 5.

At the end of an injection cycle, it may be necessary to change the mold 12 to make a new type of part or for reasons of maintenance of the mold 12 or of the injection molding machine 4. The challenge is to safely unload the mold 12, which is a very heavy steel assembly, from the injection molding machine 4.

Securing the unloading is based in particular on a synchronization of the lifting operation of the mold 12 using the hoist 56 with the demagnetization of the magnetic pads 24, and in particular the tensioning of the cable 58 vertically to the mold 12 before the demagnetization of the magnetic pads 24.

The unloading method begins with a step 1000 when the mold 12 is held in place in the injection molding machine 4 by the magnetic pads 24 which are in a magnetized state. During the step 1000, the hoist 56 is not loaded, i.e. available, and the cable 58 is, for the most part, wound around the drum 62, so that the hook 66 is in the upper position. Said step is shown on the insert A) of FIG. 2.

During a step 1002, the magnetic clamping control unit 34 checks whether the receiver 104 is operational.

Otherwise, the method switches to a manual mode and implements a step 1004 during which the operator is interrogated, by means of a human-machine interface which may be the interface formed by the control terminal 40, to determine whether the locking mechanism 42 is in the locked configuration wherein the parts 12A and 12B of the mold are secured to each other. The operator can reply to the question on the interface after visually checking the locking mechanism(s) 42. If the operator replies no or does not reply for a predetermined period of time Δt, e.g. equal to 5 seconds, the method returns to step 1000. If the operator confirms in step 1004 that the locking mechanism 42 is operational, the method moves to a step 1006 wherein the operator is asked to confirm manually that the hoist 56 has been correctly positioned and that the hook 66 is engaged in the lifting eye bolt 44. The operator can reply to the question, via the human-machine interface potentially formed by the control terminal 40, after visually checking the lifting device 50. If the operator replies no or after the expiration of a predetermined period of time Δt, e.g. equal to 5 seconds, the method returns to step 1000. If the operator confirms that the hoist is correctly attached, then the method moves to a step 1008 through a logic “OR” gate 1010.

During step 1008, the operator is interrogated, via an input interface of the magnetic clamping control unit 34, which can be integrated into the terminal 40, to know whether he/she confirms the demagnetization of the magnetic pads 24 in order to release the mold 12. If the operator does not reply within a time corresponding to a period of time Δt, e.g. equal to 5 seconds, the method automatically returns to step 1000.

If the operator confirms the demagnetization order via the input interface, the demagnetization of the magnetic pads 24 takes place during a step 1012. Thereof is signaled to the operator by a corresponding message displayed on the human-machine interface of the control terminal 40 during a step 1014. The magnetic pads of the two clamping plates of the clamping system are demagnetized simultaneously in step 1012.

After the demagnetization, the injection molding machine is opened during a step 1016, by moving the movable platen 8 away from the fixed frame 6, according to a translational movement parallel to the X axis.

The mold is then released during a step 1018 and the operator proceeds with the lifting and conveying of the mold 12 using the hoist 56, by controlling the lifting device 50 by means of the terminal 80, thereof during a step 1020 which is the end of the unloading method of the invention.

After the implementation of step 1020, the operations of changing the mold 12 continue according to known conveying procedures.

Steps 1004 and 1006 correspond to a manual implementation of the unloading method, during which the operator orders the demagnetization of the magnetic pads 24 after having himself/herself checked the state of the installation 2 and confirmed, by means of the terminal 40 and within a given time, that certain conditions are fulfilled by the locking mechanism(s) 42 and by the hoist 56.

Except where operator action is required, as explained with reference to steps 1004, 1006 and 1008, steps 1000, 1002 and 1012 to 1018 mentioned hereinabove, are carried out automatically by the clamping control unit 34 and by the control units 14 and 74 and the terminal 80.

On the other hand, the unloading method takes place after a prior conveying operation has been carried out during a step 2000 and the end of the preceding conveying has taken place during a step 2010, which makes it possible to bring the hoist 56 into a configuration where same is available, i.e. not loaded, which occurs during a step 2020.

Following step 2020, the operator communicates to the control unit 74 and via the terminal 80, instructions for positioning the carriage 52 along the X axis, thereof during a step 2030. Thereof leads to a movement of the hoist 56 which takes place during a step 2040 and normally brings the carriage into the position shown in insert B) of FIG. 2, where the transmitter 102 is vertically aligned with, and located above, the receiver 104. More particularly, the transmitter 102 is then located in the reception truncated cone K104 of the receiver 104. During a step 2050, the operator visually checks whether the carriage 52 is positioned along the X axis in such a way that the hoist 56 is above the mold 12, more particularly that the hook 56 is overall vertically aligned with the lifting eye bolt 44.

Otherwise, the movement of the hoist is restarted by the operator, by means of a return to step 2040. If such is the case, the method moves by itself to a step 2062 through an “AND” logic gate 2060.

In parallel, in step 2030 and following step 2020, the operator communicates to the control unit 74 and via the terminal 80, instructions for lowering the hook 66, thereof during a step 2070. Thereof induces a lowering of the hook 66 which takes place during a step 2072 and a locking of the hook on the lifting eye bolt 44 which takes place during a step 2074, with the help of the operator, if need be. Thereof is the configuration shown in insert C) of FIG. 3 where the cable 58 is slack.

In such position, the transmitter 102 is arranged inside the reception truncated cone K104 defined by the receiver 104.

During a next step 2076, the motor 64 is actuated to wind a portion of the cable 58 onto the drum 62, which is represented by the arrow A1 in the insert E) of FIG. 4. Thereof has the effect of placing the hook 66 under load, i.e. of placing the cable 58 under tension, by exerting the tension force F of the cable 58 between the carriage 52 and the hook 66 and which corresponds to the load on the hook.

During a following step 2078, the hook load resulting from step 2076 is determined from the load information of the sensor 68 and by means of the hook load detection device which determines the force F.

This force F determined in step 2078 is compared, during a following step 2080, with a reference value F₀ which is a threshold value. The step 2078 is preferably carried out by means of the control unit 74 of the lifting device 50.

In a variant, step 2078 is carried out at a calculator of the hook load detection device, embedded on the hoist 56, and connected to the processing means of the hook load detection device.

If the force F detected in step 2078 is strictly less than the threshold value, then a step 2082 is implemented wherein the transmitter 102 is deactivated, i.e. ceases to transmit the infrared signal SI. In such case, the control unit 74 transmits an instruction to the transmitter 102 causing the transmitter to be switched off, i.e. the emission of the infrared signal SI to be stopped. Such case corresponds to the fact that step 2078 takes place cyclically, even after the transmitter 102 has started operating following a step 2084 mentioned hereinafter, so that same serves to react to a decrease in the value of the force F during the unloading method. After step 2082, the method automatically returns to steps 2072, 2074 and 2076.

If the force F detected in step 2078 is greater than or equal to the threshold value F₀, then the method moves to a step 2084 of activating the transmitter 102, i.e. the transmission of an instruction to the power supply transmitter causing the transmitter to operate, in other words, the emission of the infrared signal IF. The transmitter 102 is set into operation by the electrical power supply of the emitter. The emission of the infrared signal SI is thereby controlled by the load detection device according to the force F determined in step 2078. If the emission of the infrared signal SI does not take place within a period less than a predetermined period, which may be equal to 500 milliseconds, the method returns to step 2080. If the emission of the infrared signal takes place during step 2084, the method moves by itself to step 2062 through the logic gate 2060.

Thereby, the “AND” logic gate 2060 makes it possible to check whether, at the same time, the carriage 52 is in the determined position and the transmitter 102 emits the signal SI.

In step 2078, the sensor 68, which is a load sensor of hoist 56, detects the increase in load on the hook.

The hook load detection device 68 comprises a calculator (not shown) which implements step 2080 and a memory (also not shown) which contains the threshold value F₀, which is e.g. equal to 500 daN. The threshold value F₀ was previously entered during the calibration of the installation 2. During step 2080, if the detected force F exceeds the threshold value F₀, the calculator considers that there is an actual hook load, i.e. a loading state of the hoist 56, and transmits a supply instruction to the transmitter causing the infrared signal to be emitted during step 2084. A corresponding information can be transmitted to terminal 80 to inform the operator of the loading state of the hoist.

In a variant, the load detection device 68 of the hoist 56 transmits information on the actual load to the position detection device 100 of the carriage 52, the position detection device 100 comprising a calculator and a memory containing the threshold value F₀. The detection device 100 then implements step 2080 of comparison between the detected force F with the threshold value F₀ and activates the infrared transmitter 102 if the force value F exceeds the threshold value F₀ or does not switch on the infrared transmitter if the force value F does not exceed the threshold value F₀.

Whatever the mode of obtaining the information on the hook load and the way the comparison of step 2080 is implemented, the transmitter receives binary information which corresponds to the result of the comparison of step 2080 and which enables or does not enable same to be set into operation.

The unloading method thus comprises preliminary steps 2000 to 2080 on which the activation of the transmitter 102 depends and which consist in particular in determining, during step 2078, the force F between the carriage 52 and the hook 66, by means of the hook load detection device 68, and to compare, during step 2080, the force F determined in the preceding step with a threshold value F₀. Said steps are carried out by the hook load detection device or by the detection device 100.

Steps 2000 to 2080 are implemented by means of the control unit 74 and the terminal 80 of the lifting device 50, whereas steps 2082 and 2084 are implemented within the detection device 100, thus by the magnetic clamping system 20.

During step 2062, which is implemented within the magnetic clamping device 20, as long as the transmitter 102 emits the infrared signal SI, the signal is assumed to be picked up by the receiver 104 and the output signal of the receiver 104 is transmitted to the clamping control unit 34, in a step 2062. In other words, step 2062 consists in collecting the state of the output signal S104 of the receiver, which enables the clamping control unit 34 to determine whether same includes the first value V1 or the second value V2.

During a step 2086 which takes place after step 1002, if the result of said step is positive, as well as after step 2062, it is verified whether the receiver 104 actually receives the infrared signal SI, by determining whether the signal S104 includes the first value V1.

Otherwise, the method automatically moves to a step 2088 prompting the operator to attach the hoist 56 and the unloading procedure is suspended, so that the magnetic pads 24 are maintained in a magnetized configuration and the mold 12 is held by the magnetic clamping device 20 in a secure manner within the injection molding machine 4, without the operator being able to progress in the mold demagnetization procedure. In other words, during step 2088, the demagnetization of the magnetic pads 24 is prevented. A fall of the mold is thereby prevented.

If the result of the verification of step 2086 is positive, i.e. if the output signal S104 includes the first value V1, and if the receiver 104 is present in step 1002, then the magnetic clamping control unit 34 considers that the transmitter 102 is, with respect to the receiver 104, in the predetermined position. The magnetic clamping control unit 34 can then authorize a demagnetization of the magnetic pads 24, during a subsequent step.

The method then moves automatically to a step 2090 comparable to step 1004 and wherein the operator is interrogated, by means of the control terminal 40, to find out whether the locking mechanism 42 is indeed in the locked configuration. The operator can reply to the question after visually checking the locking mechanism(s) 42. If the operator replies no or does not reply for a predetermined period of time Δt, e.g. equal to 5 seconds, the method moves automatically to a step 2092 wherein the operator is prompted by means of a message displayed on the terminal 80, to lock the locking mechanism(s) 42. If the operator confirms at step 2090 that the locking mechanism 42 is operational, the method moves automatically to step 1008, through the logic gate 1010. The check of the locking mechanism limits the risk of holding the mold part 12B with the lifting eye bolt 44 without holding the mold part 12A. In a variant, the check is carried out by an automatic method by means of additional sensors (not shown).

During step 1008, the operator validates the instruction to demagnetize the magnetic pads of the clamping system by means of the terminal 40, which is not prevented since the check steps have been successful.

It is then possible to implement steps 1012 to 1020, which is represented by insert F) of FIG. 4 with the arrows A2, A3 and A4.

Thereby, the authorization to demagnetize the magnetic pads which results from the verification from step 2086, when the authorization is positive, is conditioned on the result of the comparison from step 2090.

Except when an action by the operator is needed, steps 2086 to 2092 and 1012 to 1020 mentioned hereinabove are carried out automatically by the clamping control unit 34.

In summary, the steps of the unloading method of the invention involve a plurality of components of the installation 2. Steps 1002 to 1006, 1008 to 1014, 2062 and 2082 to 2092 are implemented within the magnetic clamping system 20, more particularly by means of the magnetic clamping control unit 34, of the terminal 40 and of the position detection device 100. Steps 1016 and 1018 are implemented, in particular, by means of the control unit 14 of the injection molding machine. Steps 1020 and 2000 to 2080 are implemented, in particular, by means of the control unit 74, of the terminal 80, of the motor 64 and of the sensor 68 of the lifting device 50.

More particularly, according to one aspect of the invention, the magnetic clamping system 20 is configured to implement at least steps 1012, 2062, 2084, 2086 and 2088 and, preferably, all steps 1002 to 1006, 1008 to 1014, 2062 and 2082 to 2092. Insert D) of FIG. 3 shows the case where transmitter 102 emits the infrared signal

IF without being in the predetermined position with respect to the receiver 104, to the point that the infrared signal SI emitted by the transmitter 102 is shifted from the sensor 104 along the X axis. Thereof is detected in step 2086 because the output signal S104 of the receiver 104 contains the value V2, which leads to the implementation of step 2088.

Thereby, the method of the invention allows the magnetic clamping control unit 34 to ensure that the receiver 104 is identified as present and operational during step 1002, to continue the unloading method in manual mode if the receiver 104 is not identified as present and operational, with steps 1004 to 1020 and conveying steps carried out by the operator, or to continue the unloading method in secure and semi-automatic mode if the receiver 104 is identified as present and operational, with steps 2000 to 2092, then 1008 to 1020.

The secure nature of the unloading method of the invention comes in particular from the fact that the output signal S104 of the receiver 104 keeps the second value V2, which is detected during step 2086, as long as the lifting device 50 has not been correctly positioned relative to the injection molding machine 4 during step 2040 or if the hoist 56 cannot hold the mold 12 because the load detection device, which comprises the sensor 68, did not detect any load at the hook in step 2078.

In the second and fourth embodiment of the installation 2, shown FIGS. 6 to 7, elements similar to the elements of the first embodiment have the same references. If a part of the installation 2 of the second and third embodiments is mentioned in the description without being represented in the figures, said part is the same part as the part mentioned for the first embodiment. On the other hand, if a reference is used on a part in FIG. 6 or 7 without being mentioned in the description, the part is the same as the part having the same reference in the first embodiment. Hereinafter, mainly described is what differentiates the second embodiment from the first embodiment.

In the second embodiment shown in FIG. 6, the transmitter 102 and the sensor 104 are arranged in such a way that the infrared signal SI is emitted in a direction parallel to the Y axis of the orthogonal coordinate frame XYZ. The output signal S104 of the sensor 104 includes the first value V1 when the transmitter 102 emits the infrared signal SI, and the transmitter 102 and the sensor 104 are opposite each other and aligned on the same straight line D_{SI} parallel to the Y axis, which corresponds to a predetermined position of the transmitter 102 with respect to the receiver 104. The output signal S104 of the sensor 104 includes the second value V2 when the transmitter 102 does not emit the infrared signal IF and/or when the transmitter 102 and the sensor 104 are not opposite each other and aligned on the straight line D_{FI}.

In the third embodiment shown in FIG. 7, the transmitter 102 and the sensor 104 are oriented in such a way that the infrared signal SI is parallel to the X axis of the orthogonal coordinate frame XYZ. The output signal S104 of the receiver 104 includes the first value V1 when the transmitter 102 emits the infrared signal SI and the transmitter 102 and the sensor 104 are opposite each other and aligned on the same straight line D′_{SI} parallel to the X axis, which corresponds to a predetermined position of the transmitter 102 with respect to the receiver 104. The output signal S104 of the receiver 104 includes the second value V2, when the transmitter 102 does not transmit the infrared signal IF and/or when the transmitter 102 and the sensor 104 are not opposite each other and aligned on the straight-line D′_{FI}.

The direction of detection along the straight-line D′_{SI} corresponds to the fact that the rails 154 of the lifting device 50 are supported by two carriages 57 mounted movably on two beams 55 which extend parallel to the Y axis. Thereby, the hoist 56 is movable in a horizontal plane both along the directions of the X and Y axes, and thus in particular perpendicularly to the Y axis.

In the second and third embodiments, when the transmitter 102 is in the predetermined position, the carriage 52 is vertically aligned with the mold 12 clamped in the injection molding machine.

In the second and third embodiments, the receiver 104 has a reception zone in the form of a truncated cone (not shown), according to an approach comparable to the approach of the first embodiment.

Whatever the embodiment, the unloading method and the magnetic clamping system 20 of the invention allow satisfactory positioning conditions of the hoist 56 with respect to the injection molding machine 4 to be detected to authorize the demagnetization of the magnetic pads 24. The solution of the invention has the advantage of being simple and inexpensive while being almost universal, i.e. adaptable to a large number of operating configurations. Such solution is also unidirectional because of the oriented communication from the transmitter to the receiver, without reciprocation being needed. Such solution operates without a wired link between the transmitter 102 and the receiver 104 of the position detection device 100. The solution of the invention also has the advantage of being secure and tamper-proof because the detection of the electromagnetic signal is only possible under unique alignment conditions.

The invention is not limited to a type of lifting device. In a variant, the lifting device may be a chain or sling lifting device, a robot or a crane.

According to a variant of the invention (not shown), the transmission direction of the transmitter 102, the reception direction of the receiver 104 and the reception truncated cone K104 can be inclined, in all directions, with respect to the axes XYZ.

According to another variant of the invention (not shown), the transmitter can emit an electromagnetic signal other than an infrared signal, in particular a laser signal or a unidirectional electroluminescent signal emitted by a light-emitting diode, in other words an LED. In such case, the receiver 104 is configured to detect a laser signal or an electroluminescent signal.

The invention is not limited to a use withing the framework of a plastics processing installation but applies to other types of installation which comprises machines, parts of which gave be replaced during the service life of the machines, such as machining centers. More particularly, the invention can be applied to machining centers with vertically arranged magnetic clamping plates where the risk of workpiece falling is present during demagnetization.

According to a variant of the invention (not shown), applicable to all embodiments, the hook load detection device, which comprises the sensor 68 and the means (not shown) for processing the output signal thereof, can be configured to determine, on the basis of the force between the carriage 52 and the hook 66, the mass of the part to be clamped, namely the mold 12 in the embodiments shown. In such case, the electromagnetic signal emitted by the transmitter 102 advantageously includes information relating to the mass of the part to be clamped, as determined by the hook load detection device. The receiver 104 is then configured to extract the information relating to the mass of the part to be clamped from the electromagnetic signal received from the transmitter 102 and to communicate same to the magnetic clamping control unit 34. In such case, when loading a mold 12 into an injection molding machine 4 or another part to be clamped on another machine, the loading method of said part may include a step, carried out within the magnetic clamping control unit 34 and consisting in comparing the information relating to the mass of the part to be clamped, extracted from the electromagnetic signal emitted by the transmitter 102, with a predetermined threshold value. When the hereinabove comparison shows that the mass of the workpiece to be clamped is greater than the threshold value, an additional step can be carried out, also within the magnetic clamp control unit 34, to prevent the part from being loaded or to issue an alarm. On the other hand, in the case where the aforementioned comparison shows that the mass of the part to be clamped is less than the threshold value, a step can be carried out within the magnetic clamping control unit 34 to authorize the loading of the part into the machine.

Thereby, in the example of a mold, if a mold 12 is brought by the hoist 56 to an injection molding machine 4 the magnetic clamping capacities of which are limited to a threshold value, clamping can be prevented or an alarm can be triggered prior to the clamping operations as such.

According to another variant, applicable to all the embodiments of the invention, the electromagnetic signal emitted by the transmitter 102, e.g. the infrared signal SI, may comprise an identification frame Ti₁₀₂ for the transmitter, intended to be collected by the receiver 104. In such case, the method comprises an additional step (not shown) and e.g. implemented between steps 2060 and 2090, during which the identification frame Ti₁₀₂ is compared with a reference identification frame Tref₁₀₂, assigned to the transmitter 102 assumed to belong to the same position detection device 100 as the receiver 104. If the result of the comparison is negative, i.e. if the frames Ti₁₀₂ and Tref₁₀₂ are different, the method returns to step 2088 regardless of the value V1 or V2 included in the signal S104. If the result of the comparison is positive, the method moves to step 2090. It is thereby possible to guarantee that the signal detected by a sensor 104 corresponds to the hoist 56 associated with a row of machines which includes the machine relative to the clamping plate of which the receiver is fixed and that same is not a parasitic electromagnetic signal coming from a neighboring equipment.

According to another variant applicable to all embodiments, the receiver 104 is mounted on a fixed part of the installation 2 but offset from the clamping plate 26, in order to reduce environmental constraints, in particular in terms of cabling.

In a variant, the position of the receiver 104 can be adapted on the machine, e.g. by means of a slide and a clamping means which serve to fasten the receiver on the machine in one of a plurality of possible positions.

In a variant, a plurality of emitters 102 and/or a plurality of receivers 104 may be used for the same machine, in particular the same injection molding machine 4, and the same hoist 56. It is thereby possible to ensure that the positioning of the hook 66 is correct along two perpendicular directions, in particular when the hoist 56 can move along the axes X and Y as in the third embodiment. In such case, it is possible to combine the orientations of the parts of the position detection device 100 shown in FIGS. 6 and 7. The demagnetization authorization then depends on the combined reception of a plurality of signals.

According to another variant of the invention (not shown), each mold part 12A and 12B is equipped with a lifting eye bolt 44 and handled independently during the operations of unloading and loading the mold into the injection molding machine. In such case, it is not necessary to provide a locking mechanism 42 and steps 1004 and 2090 of the method are not implemented. In such case, the demagnetization of the magnetic pads 24 is controlled independently for the two clamping plates 26 and 28.

In a variant, the mold 12 may comprise more than two parts 12A and 12B, manipulated in one go or independently.

According to another variant, the truncated cone K104 may be a cone, if the detection zone of the receiver 104 is isolated.

The aforementioned embodiments and variants of the invention can be combined with each other so as to generate new embodiments.

1. A method for unloading, by means of a hoist, at least one workpiece clamped on a magnetic clamping system of an industrial installation, the hoist comprising
a carriage movable in a horizontal plane,
a hook suspended from the carriage and movable vertically,
a hook load detection device configured to determine a force between the carriage and the hook and
a hoist control unit,
the magnetic clamping system comprising
a magnetic clamping control unit,
at least one magnetic clamping plate comprising a plurality of selectively magnetizable magnetic pads controlled by the magnetic clamping control unit,
a human-machine interface connected to the magnetic clamping control unit and used to enter a demagnetization order of the magnetic pads
wherein
the magnetic clamping system includes a detection device for detecting a position of the carriage relative to the clamping plate, the detection device comprising:
a transmitter of an electromagnetic signal, secured to the carriage and controlled according to the force determined by the hook load detection device,
a receiver for the electromagnetic signal emitted by the transmitter, fixed with respect to the clamp plate and configured to provide an output signal including a first value when the receiver receives the electromagnetic signal and a second value when the receiver does not receive the electromagnetic signal, and
the unloading method comprises at least the steps consisting of
a) determining the force between the carriage and the hook by means of the hook load detection device,
b) comparing the force determined in step a) with a threshold value,
c) if the comparison made in step b) shows that the force determined in step a) is higher than the threshold value, activating the transmitter,
d) during step c), collecting the receiver output signal,
e) determining (2086) which value is included in the output signal of the receiver, among the first value and the second value,
f) if the determination of step e) shows that the output signal collected in step d) includes the first value, authorizing the entry of an order to demagnetize the magnetic pads by means of the human-machine interface,
g) if determination of step e) shows that the output signal collected in step d) includes the second value, preventing (2088) the entry of the order to demagnetize the magnetic pads by means of the human-machine interface.

2. The unloading method according to claim 1, wherein step g) is maintained as long as the signal collected in step d) has the second value.

3. The unloading method according to claim 1, wherein the receiver outputs the output signal with the first value when the transmitter is activated and the transmitter is in a predetermined position relative to the receiver, and wherein the receiver outputs the output signal with the second value when the transmitter is not operating and/or the transmitter is not in the predetermined position relative to the second element.

4. The unloading method according to claim 3, wherein the predetermined position of the transmitter is opposite the receiver.

5. The unloading method according to claims 3 4, wherein that the predetermined position of the transmitter corresponds to a vertical alignment of the carriage with the part clamped on the magnetic clamping system.

6. The unloading method according to claim 1, wherein
the electromagnetic signal transmitted by the transmitter includes an identification frame intended to be collected by the receiver
the method comprises an additional step h) of comparison between the identification frame collected by the receiver and a reference identification frame and
in the case where the result of the comparison of step h) is negative, the entry of the instruction for demagnetizing the magnetic pads is prevented regardless of the value determined in step e).

7. The unloading method according to claim 1, wherein the method comprises additional steps consisting of:
i) prior to step (c), determining whether the receiver is operational,
j) if the receiver is determined to be operational in step i), moving to step (e)
(k) if the receiver is determined to be non-operational in step i), switching to a manual mode where the operator has to validate at least one step by answering a question, by means of a control terminal connected to the magnetic clamping control unit (34).

8. A magnetic clamping system comprising a magnetic clamping control unit and at least one magnetic clamping plate comprising a plurality of selectively magnetizable magnetic pads controlled by the magnetic clamping control unit, wherein
the magnetic clamping system includes a detection device for detecting a position of a carriage of a lifting device relative to the magnetic clamping plate, the detection device comprising:
a transmitter of an electromagnetic signal, secured to the carriage,
a receiver of the electromagnetic signal emitted by the transmitter, fixed in relation to the clamping plate, configured to provide an output signal including a first value when the receiver receives the electromagnetic signal and a second value when the receiver does not receive the electromagnetic signal,
the clamping system being configured to carry out at least steps c) to g) of a method according to claim 1.

9. The magnetic clamping system according to claim 8, wherein the electromagnetic signal is an infrared signal and wherein the receiver is configured to detect an infrared signal.

10. The magnetic clamping system according to claim 8, wherein the electromagnetic signal is emitted by a laser diode or a light-emitting diode and in that the receiver is configured to detect a laser signal or a light-emitting signal.

11. The magnetic clamping system according to claims 8, wherein the receiver is directed along a vertical axis and in that a reception zone of the receiver has the shape of a cone or of a truncated cone centered on the vertical axis.

12. The magnetic clamping system according to claims 8, wherein the receiver is directed along a horizontal axis and in that a reception zone of the receiver has the shape of a cone or of a truncated cone centered on the horizontal axis.

13. The magnetic clamping system according to claims 8, wherein the receiver comprises a microcontroller apt to communicate the first value or the second value included in the output signal to the magnetic clamping control unit.

14. The magnetic clamping system according to claims 8, wherein the receiver is configured to output a presence information to the magnetic clamping control unit.

15. A loading method, using a hoist, at least one workpiece to be clamped onto a magnetic clamping system of an industrial installation,
the hoist comprising
a carriage movable in a horizontal plane,
a hook suspended from the carriage and movable vertically,
a hook load detection device configured to determine a force between the carriage and the hook and
a hoist control unit, characterized in that
the magnetic clamping system is according to claim 8
the hook load detection device is configured to determine, based on the force between the carriage and the hook, the mass of the workpiece to be clamped,
the electromagnetic signal emitted by the transmitter includes information on the mass of the part to be clamped, determined by the hook load detection device,
the receiver is configured to extract the mass information of the workpiece from the electromagnetic signal received from the transmitter and communicate same to the magnetic clamping control unit of the magnetic clamping system.
the unloading method includes at least steps performed by the magnetic clamping system and consisting of
1) comparing the information on mass of the part to be clamped, extracted from the electromagnetic signal, with a predetermined threshold value,
m) if the comparison made in step (l) shows that the mass of the part to be clamped is greater than the threshold value, preventing the loading or emitting an alarm, and
n) if the comparison made in step (l) shows that the mass of the part to be clamped is less than the threshold value, authorizing the loading.
